(19) United States
(12) Patent Application Publication
(10) Pub. No.: US 2009/0031900 A1
(43) Pub. Date: Feb. 5, 2009

(54) COFFEE MAKER

(76) Inventors: JAMES R. BARRACLOUGH, Lanchashire (GB); DAVID J. WANAT, Meriden, CT (US); BARBARA L. SCHNABEL, Chappaqua, NY (US)

Correspondence Address: Lawrence Cruz;Conair Corporation, One Cummings Point Road, STAMFORD, CT, 06902, US

(21) Appl. No.: 12/109,783

(22) Filed: Apr. 25, 2008

Related U.S. Application Data
(60) Provisional application No. 60/934,232, filed on Jun. 12, 2007.

(51) Int. Cl. A47J 31/10; A47J 31/40; A47J 31/42; A47J 31/56

(52) U.S. Cl. 99/280; 99/286; 99/304; 99/306

(57) ABSTRACT

A coffee maker including a base, a housing, a hopper, a burr grinding assembly, and a brew basket is provided for automatic self-metered grinding and brewing of coffee. A cover is provided for the brew basket to prevent moisture from reaching the whole coffee beans in the hopper.

### TECHNICAL FIELD

The present invention relates to food and beverage appliances. More particularly, the present invention relates to coffee makers.

### DESCRIPTION OF THE RELATED ART

Drip style coffee makers exist with various automatic features including, for example, automatic grinding of whole coffee beans and timer-controlled operation of the coffee maker unit. In typical operation, a selected amount of whole coffee beans are loaded into a compartment of the coffee maker and subjected to grinding operations. The resulting ground coffee rests in a brew basket as heated water is passed therethrough, under gravity, to produce brewed coffee.

It would be advantageous to provide a drip style coffee maker having self-metered grinding capabilities of whole coffee beans. Further, it would be advantageous to provide a coffee maker having automatic burr grinding capabilities of whole coffee beans to produce uniform and consistent coffee grind size. Additionally, it would be advantageous to provide a coffee maker having moisture protection for coffee beans that are in the grinding section but not in the brewing basket.

### SUMMARY

The present disclosure is directed to a coffee maker having a base, a housing extending substantially vertically from the base, a bean hopper, a burr grinder assembly, and a brew basket having a rotatable cover. In one embodiment, the coffee maker includes a base, a housing extending substantially vertically from the base, and having a water reservoir and a heater element, a hopper removably mounted to the housing and possibly having a partition wall, a grinding assembly having an upper burr disc attached to the hopper and a lower burr disc attached to an internal motor for grinding whole beans and a brew basket, e.g., a filtered brew basket. The brew basket includes a rotatable cover wherein ground coffee passes from the grinding assembly into the brew basket when the cover is open and prevents moisture from entering the hopper when the cover is closed.

In one embodiment, the cover of the brew basket may be rotatably controlled by a synchronous motor. The hopper may have a rotary dial operably connected to a rotary door for selectively closing the hopper from the housing. The housing further includes an electrical safety switch to ensure operation of the coffee maker only when the hopper is properly and securely positioned. A release button may be provided for releasing the hopper. The housing further may include a water level indicator, and a hinged funnel door for adding water to the coffee maker. A water filter may be included to filter impurities from the water in the water reservoir. the water filter is a charcoal filter.

A control panel may be included to control operation of the coffee maker. The control panel includes controls having at least an indicator, a button, and a dial. The control panel may have a grind control for automatic self-metering of the whole coffee beans. The controls may be selected from the group consisting of a programmable clock, a time display, an automatic shutoff, an automatic turn-on, a grind control, a strength control, combinations thereof, and the like.

In another embodiment, a coffee maker includes a housing, a hopper, and a brew basket. The housing has a base, a water reservoir and a heater element. The hopper may further possess a rotary dial operably connected to a rotary door. A burr grinding assembly having a stationary disc attached to the hopper and a rotary disc attached to a motor may be provided. A brew basket having a cover is disposed relative to the hopper.

### BRIEF DESCRIPTION OF THE DRAWINGS

Preferred embodiments of the present disclosure will be better understood by reference to like drawings wherein:

FIG. 1 is a frontal plan view of the coffee maker in accordance with the present disclosure;

FIG. 2 is a perspective view of the coffee maker of FIG. 1;

FIG. 3 is a perspective view of another embodiment of the coffee maker in accordance with the present invention;

FIG. 4 is a side cross-sectional side view of the coffee maker of FIG. 1;

FIG. 5 is another perspective view of the coffee maker of FIG. 1;

FIG. 6 is an exploded view of the hopper of the coffee maker of the present disclosure;

FIG. 7 is a back cross-sectional view of another embodiment of the coffee maker in accordance with the present invention;

FIG. 8 is an exploded view of the burr grinding assembly of the coffee maker of the present disclosure; and

FIG. 9 is an exploded view of the brew basket of the coffee maker of the present disclosure.

### DETAILED DESCRIPTION OF THE EMBODIMENTS

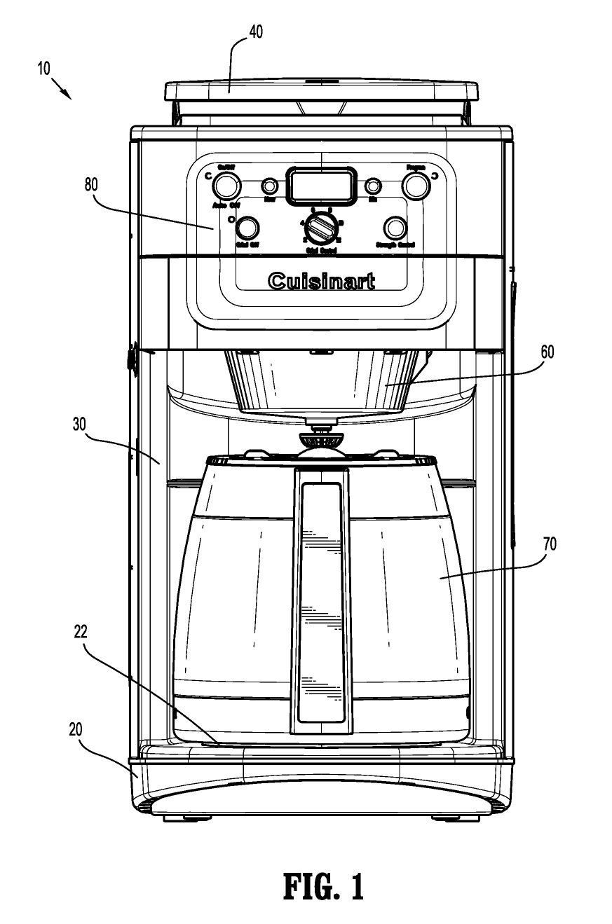

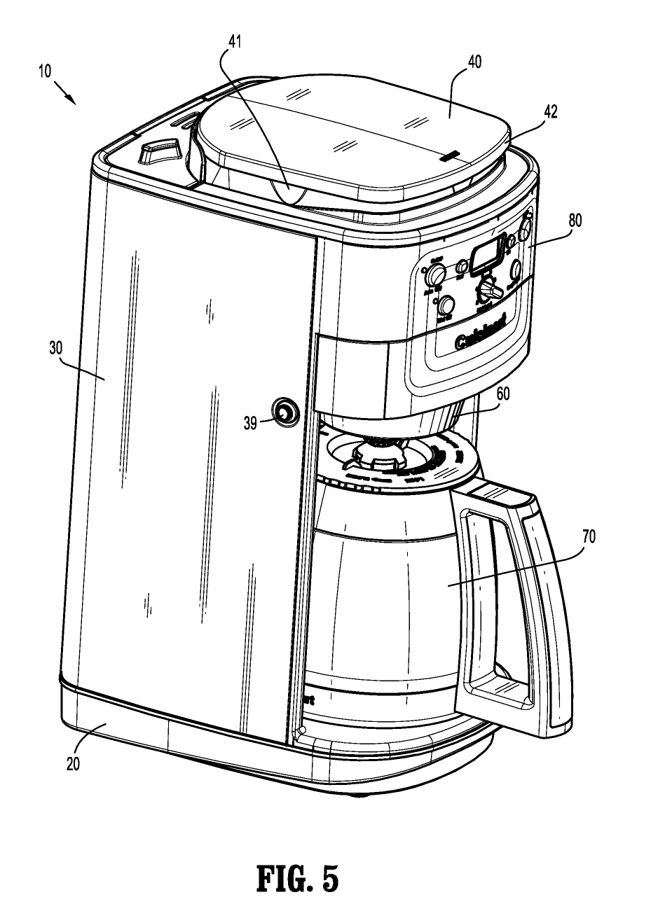

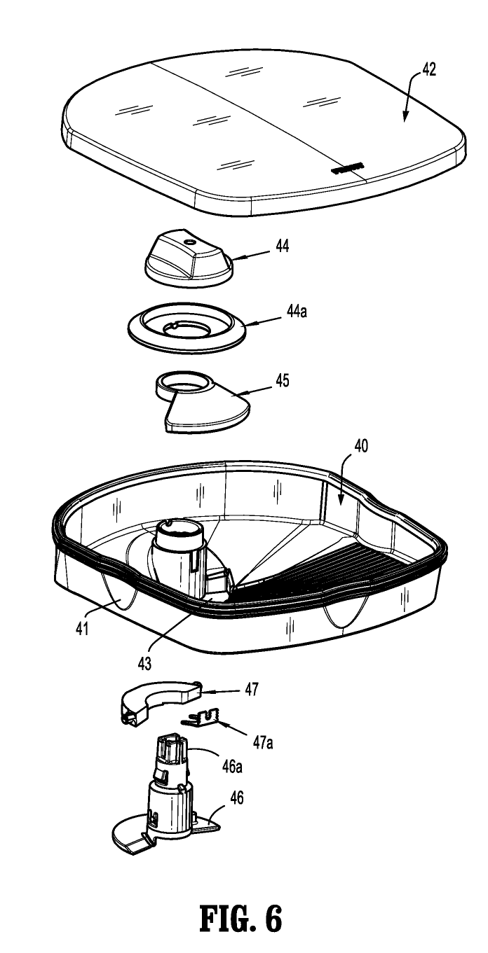

The present disclosure is directed to a coffee maker. The coffee maker is capable of grinding and brewing whole coffee beans or brewing pre-ground coffee. Embodiments of the present disclosure are illustrated in FIGS. 1-9.

Referring now to the drawings, in which like reference numerals identify identical or substantially similar parts throughout the several views, FIG. 1 illustrates a front view of the coffee maker in accordance with the principles of the present disclosure. Coffee maker 10 includes base 20, housing 30, hopper 40, grinding assembly 50, brew basket 60, carafe 70, and control panel 80. Base 20 is shaped to accommodate carafe 70. Optionally, base 20 may contain heater plate 22 to maintain the brewed coffee in carafe 70 in a temperature range about the brewing temperature. Housing 30 extends substantially vertically from base 20 and may be separate from or integrally formed with base 20. Housing 30 contains a water reservoir and an internal heater element.

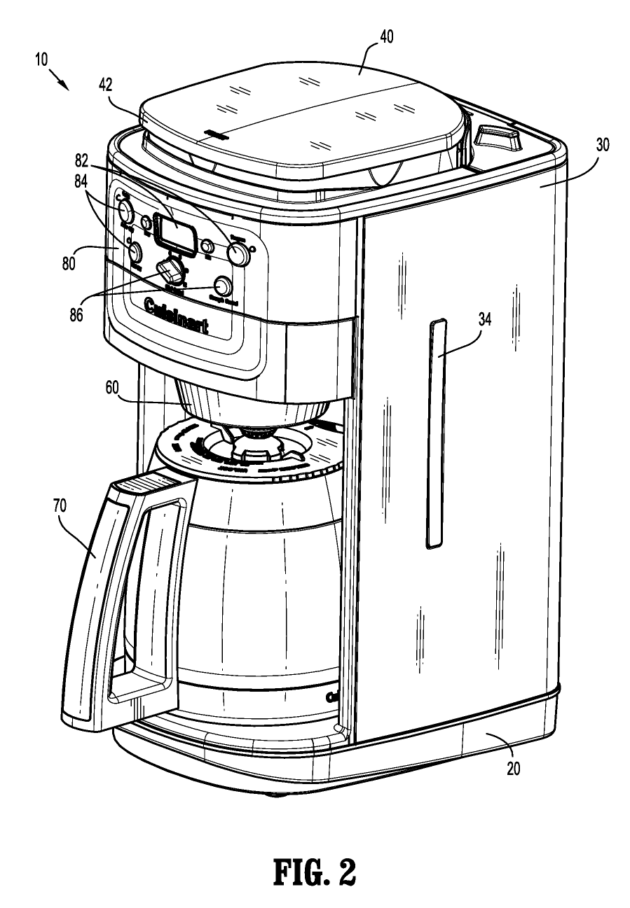

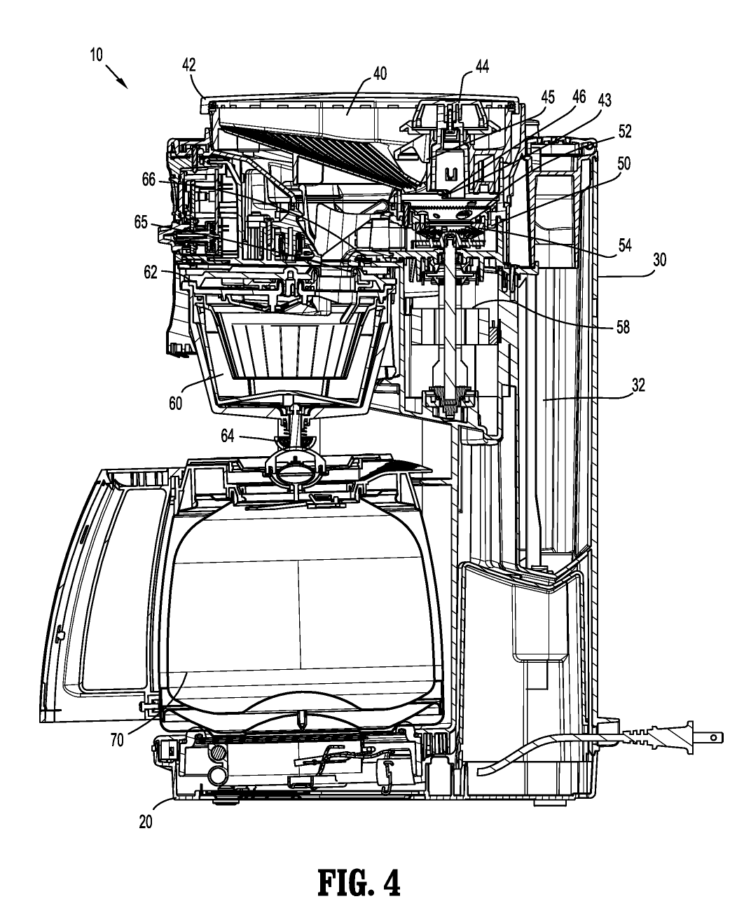

Referring to FIGS. 2 and 4, water reservoir 32 is a cavity formed by the interior walls of housing 30. A filter (not shown), such as a charcoal filter, may be situated in water reservoir 32 for removing impurities such as bacteria, chemicals, and minerals, as well as bad tastes and odors from the water. Optionally, housing 30 may have water level indicator 34, such as a water window, for visual inspection of the water level within coffee maker 10. Water level indicator 34 may have water level markings, an internal floating ball, or other configurations that are within the purview of those skilled in the art.

The internal heater element (not shown) heats the water in water reservoir 32. The heater element may be any component within the purview of those skilled in the art capable of heating water. Heated water moves, under pressure, through conduits to a drip nozzle. The drip nozzle may be any fluid carrying mechanical device within the purview of those skilled in the art capable of directing and controlling the flow of heated water.

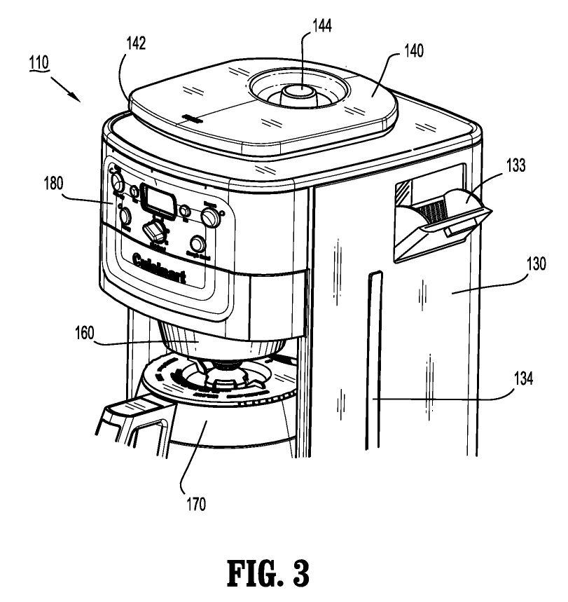

FIG. 3 illustrates an alternative embodiment of coffee maker 10 shown generally as 110. Housing 130 has hinged funnel door 133. Hinged funnel door 133 may be opened to allow for the input of water into water reservoir 132 or closed to lay flush with the housing 130. Any suitable door may be used with the coffee maker of the present disclosure as known to those skilled in the art for filling the coffee maker with water.

Referring now to FIGS. 4-6, bean hopper 40 is removably mountable in housing 30. Bean hopper 40 is configured to receive and hold coffee beans. Hopper 40 may have a funnel-shaped bias leading to opening 43. The sloped configuration creates a path for delivery of the coffee beans to grinding assembly 50.

Release button 39 may be provided for convenient release of hopper 40. Release button 39 may be positioned on housing 30 or on hopper 40. Release button 39 is associated with a mechanism, such as a pop-up mechanism, to release hopper 40. The mechanism can be any mechanism within the purview of those skilled in the art for ease in removing hopper 40 from housing 30, such as, for example, a spring mechanism or a fastener and a driving device. Hopper 40 may optionally have finger grips 41 to manually remove hopper 40 from coffee maker 10.

Lid 42 may be removably or hingedly attached to hopper 40. Rotary dial 44 may be disposed inside hopper 40 under lid 42. Alternatively, as shown in FIG. 3, lid 142 may have rotary dial 144 positioned therethrough.

Rotary dial 44 controls the position of rotary door 46. Rotary door 46, in turn, controls whether anything passes into grinding assembly 50 through hopper 40 by covering or uncovering opening 43. Rotary door 46 is secured to hopper 40 via hopper lock 47 and associated hopper lock holder 47a. Rotary door 46 also has mating end 46a for receiving rotary dial 44. Rotary dial 44 may be directly connected to mating end 46a of rotary door 46. Rotary dial 44 may also sit within a casing 44a or have hopper eave 45.

Rotary door 46 closes off opening 43 of hopper 40 to prevent spillage of coffee beans if hopper 40 is removed from housing 30. Other suitable means within the purview of those skilled in the art may be used to control rotary door 46, such as, for example, a button, knob, switch, or lever.

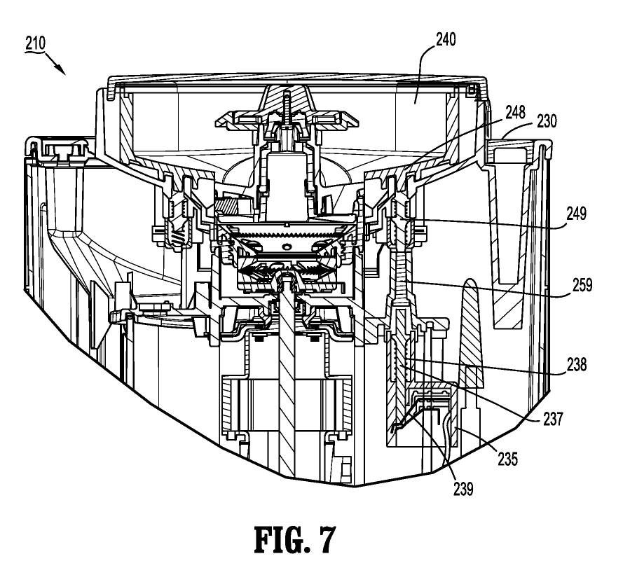

FIG. 7 illustrates an alternative embodiment of coffee maker 10 as shown generally as 210. Electric safety switch 235 is provided to prevent coffee maker 210 from operating unless hopper 240 is properly and securely positioned therein. Electric safety switch 235 includes switch actuator 237, switch spring 238, and safety contacts 239. Electric safety switch 235 may be positioned inside housing 230 and may be capable of being suppressed and engaged only when hopper 240 is situated correctly in coffee maker 210. Hopper 240 has foot 248 which depresses hopper actuator bracket 249, motor actuator bracket 259, and switch actuator 237. Switch actuator 237 lowers switch springs 238 which allows safety contacts 239 to make contact, rendering coffee maker 210 operable.

Hopper 40 may optionally have a partition wall to keep two groups of whole coffee beans separated. This allows for two different types of beans to be selectively loaded, whereby they are fed into grinding assembly 50 simultaneously or, if desired, separately, for selective grinding and blending.

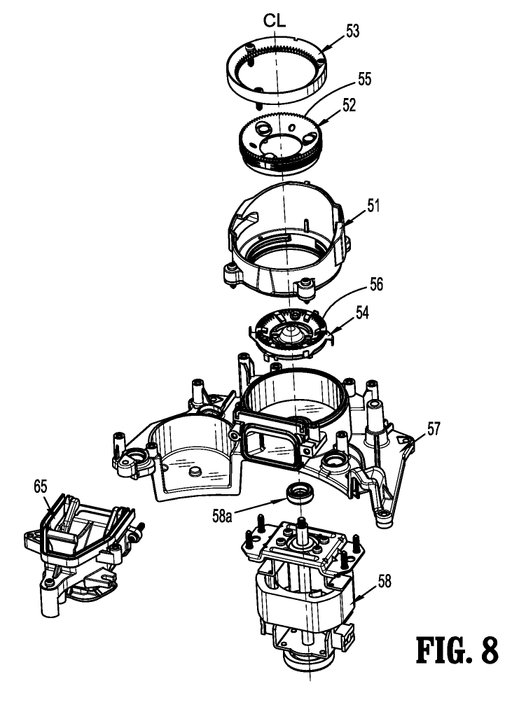

Referring now to FIG. 8, grinding assembly 50 has burr discs 52, 54. Burr discs, 52, 54 have a plurality of serrations, 55, 56 respectively, in configurations that are within the purview of those skilled in the art. Upper burr disc 52 is situated within grinder bracket 51 and fixed in place by upper burr lock 53. Upper burr disc 52 is also attached to hopper 40 and remains stationary. Lower burr disc 54 is mounted in motor bracket 57. Internal motor 58, fitted with oil seal 58a, is connected to motor bracket 57 and rotates lower burr disc 54. The coffee beans are metered between two discs 52, 54 and crushed to a uniform size and consistency. Motor 58 is of any suitable type for providing suffient rotational speed or torque to upper and lower discs 52, 54 to process or grind whole coffee beans into coffee grinds. Upper and lower discs 52, 54 are mounted so as to rotate about a vertical axis. Upper and lower discs 52, 54 may also be disposed to operatively rotate about any other axis suitable for operation in coffee maker 10. The coffee beans, once ground, fall into brew basket 60 via grind chamber tunnel 65.

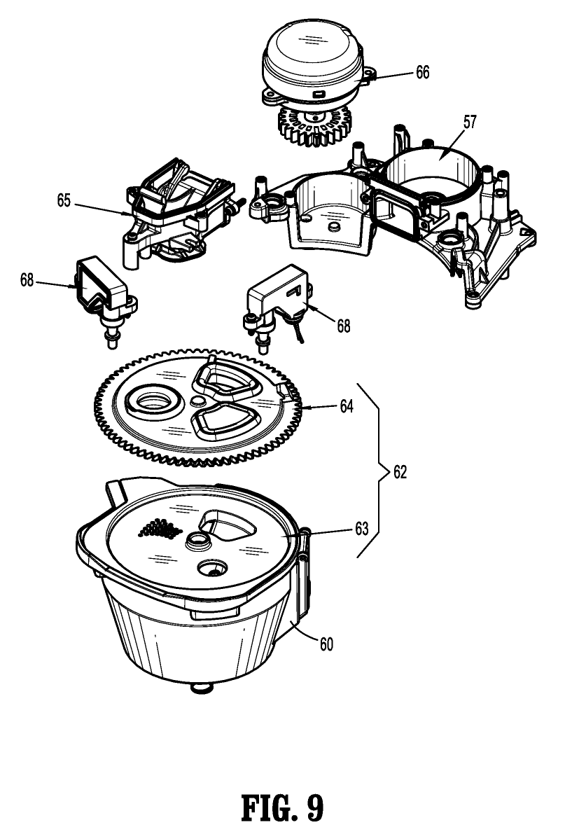

Referring now to FIGS. 4 and 9, brew basket 60 has cover 62 to separate basket 60 from the interior of housing 30. Cover 62 has cover plate 63 and cover gear 64 for rotatably selecting whether brew basket 50 is covered or uncovered. Any suitable mechanism, such as a spring loaded plate, may be used for blocking the passage between brew basket 50 and hopper 40. Synchronous motor 66, which is controlled by microswitches 68, directs rotation of cover 62. Cover 62 automatically rotates in and out of position depending on whether grinding assembly 50 is in use. Cover 62 will unblock the opening leading to hopper 40 when the grinding assembly is engaged in order to deliver ground coffee from grinding mechanism 50 to brew basket 60. When the grinding assembly is not in use, cover 62 will block the exit of steam from brew basket 60 into the opening leading to hopper 40 to prevent moisture from reaching the unground coffee beans.

Brew basket 60 may hold a replaceable brew filter or disposable filters. Brew basket 60 may also have poppit valve 64 for transferring brewed coffee into carafe 70. Poppit valve 64 controls the flow of coffee out of the brew basket into carafe 70. When carafe 70 is removed brewed coffee stops flowing until carafe 70 is returned to its original position on base 20 of housing 30.

Control panel 80, such as that shown in FIGS. 1-3 and 5, has a number of controls. Indicators 82 on control panel 80, include, for example, an “on/off” indicator, an “auto on” indicator, a “grind off” indicator, a strength control indicator, a grind control indicator, and a display, such as a liquid crystal display (LCD). Control panel 80 also has a number of control buttons 84, such as, for example, hour and minute buttons for a programmable real time clock, an “on/off” button, a programmable “auto-on” button, a “grind off” button, combinations thereof, and the like. Control panel 80 may also have control dials 86, such as a grind control dial and a strength control dial.

In embodiments, a dial is available for selecting the quantity of coffee to be brewed. The user will choose the number of cups, generally ranging from about 2 to about 12, which in turn controls the amount of beans delivered from the hopper to the grinding assembly.

Control buttons 84 and dials 86 cooperate with indicators 82 and a microprocessor to control coffee maker 10 in accordance with the user's desire. Optionally, other features may be controlled via the microprocessor and control panel 80, such as a power loss back-up feature and an audible ready indicator feature.

Coffee is made by the coffee maker of the present disclosure by filling the water reservoir with water and setting the appropriate controls on the control panel. The hopper, filled with whole coffee beans, are ground within the grinding assembly and delivered to the brew basket. Alternatively, the brew basket may be manually filled with pre-ground coffee. The water is heated by the heater element and moves, under pressure, through conduits to the drip nozzle positioned above the brew basket. The heated water passes through the coffee grinds in the brew basket and freshly brewed coffee drips into the carafe.

To use the coffee maker of the present disclosure, the coffee maker is plugged into an electric outlet. In embodiments, if the user desires use of pre-ground coffee, the user fills the water reservoir with water and adds the coffee grounds to the brew basket. The user selects a mode in which the grinder is OFF, and also sets other controls as desired. After positioning the carafe below the brew basket, the unit is turned ON, and freshly brewed coffee will drop into the carafe.

In embodiments, if the user desires the use of whole beans, the user fills the water reservoir with water and adds whole beans into the hopper. The user will turn the rotary door to the open position using the rotary dial. A dial allows the user to choose the amount of beans to be delivered from the hopper (4/6/8/10/12 cups) to the grinding assembly and to set the strength of the coffee (strong/medium/mild), among other options. After positioning the carafe below the brew basket, the unit is turned ON and freshly brewed coffee will drop into the carafe.

It will be understood that various modifications may be made to the embodiments disclosed herein. Therefore, the above description should not be construed as limiting, but merely as an exemplification of preferred embodiments. Those skilled in the art will envision other modifications within the scope and spirit of the present disclosure. Such modifications and variations are intended to come within the scope of the following claims.

What is claimed is:

1. A coffee maker comprising:
a base;
a housing extending substantially vertically from the base, the housing including a water reservoir and a heater element;
a hopper removably mounted to the housing;
a grinding assembly comprising an upper burr disc attached to the hopper and a lower burr disc attached to an internal motor for grinding whole beans; and
a brew basket having a rotatable cover, wherein ground coffee passes from the grinding assembly into the brew basket when the cover is open and prevents moisture from entering the hopper when the cover is closed.

2. The coffee maker of claim 1 wherein the cover of the brew basket is rotatably controlled by a synchronous motor.

3. The coffee maker of claim 1 wherein the hopper has a rotary dial operably connected to a rotary door for selectively closing the hopper from the housing.

4. The coffee maker of claim 1 wherein the housing further comprises an electrical safety switch to ensure operation of the coffee maker only when the hopper is properly and securely positioned.

5. The coffee maker of claim 1 further comprising a release button for releasing the hopper.

6. The coffee maker of claim 1 wherein the housing further comprises a water level indicator.

7. The coffee maker of claim 1 wherein the housing further comprises a hinged funnel door for adding water to the coffee maker.

8. The coffee maker of claim 1 wherein the housing further comprises a water filter to filter impurities from the water in the water reservoir.

9. The coffer maker of claim 8 wherein the water filter is a charcoal filter.

10. The coffee maker of claim 1 further comprising a control panel.

11. The coffee maker of claim 10 wherein the control panel further comprises controls having at least an indicator, a button, and a dial.

12. The coffee maker of claim 10 wherein the control panel has a grind control for automatic self-metering of the whole coffee beans.

13. The coffee maker of claim 11 wherein the controls are selected from the group consisting of a programmable clock, a time display, an automatic shutoff, an automatic turn-on, a grind control, a strength control, combinations thereof, and the like.

14. The coffee maker of claim 1 wherein the hopper has a partition wall.

15. The coffee maker of claim 1 wherein the brew basket is filtered.

16. A coffee maker comprising:
a housing, a hopper, and a brew basket,
the housing having a base, and comprising a water reservoir and a heater element,
the hopper having a rotary dial operably connected to a rotary door, and comprising a burr grinding assembly, the burr grinding assembly having a stationary disc attached to the hopper and a rotary disc attached to a motor, and
a brew basket having a cover.
